(19) United States
(12) Patent Application Publication
(10) Pub. No.: US 2010/0088624 A1
(43) Pub. Date: Apr. 8, 2010

(54) ANIMATION TOOL

(75) Inventors: James Bligh, Dublin (IE); Mark Tangney, Cork (IE); Brendan Tangney, Dublin (IE); Chris Collins, Dublin (IE)

Correspondence Address: SEYFARTH SHAW LLP, WORLD TRADE CENTER EAST, TWO SEAPORT LANE, SUITE 300, BOSTON, MA, 02210-2028, US

(73) Assignees: The Provost, Fellows and Scholars of the College of the Holy and Undivided Trinity of Queen Elizabe, Dublin (IE); University College Cork-National University of Ireland, Cork (IE)

(21) Appl. No.: 12/244,893

(22) Filed: Oct. 3, 2008

(51) Int. Cl. G06F 3/048

(52) U.S. Cl. 715/769

(57) ABSTRACT

An animation tool which is configured to enable a user to generate one or more animations for subsequent execution on a computer platform is described. The animation tool provides a plurality of graphical integers which a user can use to generate an animation. The graphical integers are divisible into graphical elements and graphical element effects, the effects being applied by a user onto an element and defining the viewing properties of that element.

### FIELD OF THE INVENTION

The present invention relates to animation tools and particularly to a browser based animation tools

### BACKGROUND

Animation tools are well known in the art. Such tools have degrees of complexity ranging from the complex type used for motion picture animations to simple versions such as used in presentations where an object can be moved so as to emphasis a point.

To create these animations a user typically requires familiarity with the software packages that are used to generate the ultimate animation. These packages can require a high level of familiarity before a user can easily generate animations. This long lead-in learning time and requirement for some level of artistic creativity and knowledge of the underlying principles that govern how animations are generated prejudices users without that time or knowledge from generating animations.

There is a desire for such users to be able to readily generate animations for use for example in presentations or the like without requiring a detailed knowledge of the complex environment of the commercial animator. There is a further need for such a user to be able to readily generate and store animations and share those with other similar users.

### SUMMARY OF THE INVENTION

These and other problems are addressed by an animation tool which is provided in a client server architecture, functionality of the tool residing on a server which is then accessible by a user over a browser connection from a client machine.

The animation tool includes a graphical user interface to a datastore providing a plurality of graphical elements which can be individually selected by the user and placed onto a worksheet. The graphical user interface desirably is configured to portion the available client screen into distinct regions; a first region being provided as the worksheet area where a user can pick and place graphical elements for subsequent generation of an animation. A second region which is desirably dimensioned smaller than the first region provides graphical representations of each of the available graphical elements that are available. A third region which is also desirably dimensioned smaller than the first region provides graphical representations of each of graphical element effects that may be applied onto each of the graphical elements.

Each of the second and third regions are desirably provided on the same area of the screen but are sequentially viewable by the user through a tab menu whereby the first and second region will interchange.

The tool enables a user to select individual graphical elements from the second region and place them using a mouse onto the first region. The desired graphical element effect for that graphical element may then be associated with that graphical element by dragging that effect from the third region onto the appropriate graphical element that is provided on the first region. It will be appreciated that the effects and the elements are orthogonal to one another in that the attributes of the graphical element are independent of the properties resultant from association of the graphical element effect with that graphical element.

These and other features will be better understood with reference to the following drawings which are provided to assist with an understanding of the teaching.

### BRIEF DESCRIPTION OF THE DRAWINGS

The present invention will now be described with reference to the accompanying drawings in which:

FIG. 1 is a schematic of a server client architecture usefully employed within the context of the present invention.

FIG. 2 is a screen shot showing a graphical user interface provided by a tool in accordance with the present teaching.

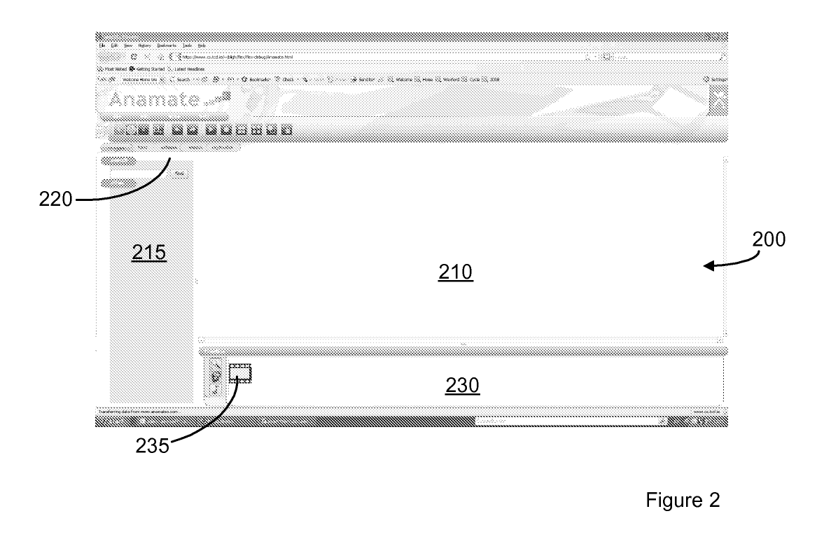

FIG. 3 is a screen shot showing how a user may populate a frame with graphical elements.

FIG. 4 is a screen shot showing how the user may then subsequently apply graphical effects to such elements.

### DETAILED DESCRIPTION OF THE DRAWINGS

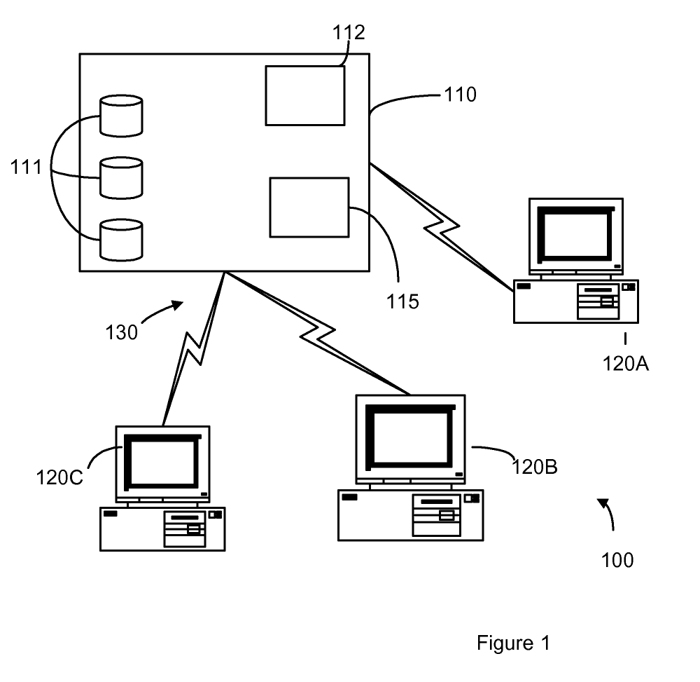

FIG. 1 is a schematic representation showing an exemplary client server architecture that may be configured to provide an animation tool 100 in accordance with the present specification.

Such an architecture includes a plurality of client devices 120A, 120B, 120C each of which can independently interact with a server 110 over one or more communication links 130. Such communication will be familiar to those skilled in the art as being of the type typically employed in an internet environment where the client devices use web browser software to access one or more programs that are executable on a remote server.

Using the browser software such as provided by Internet Explorer™ Mozilla™, Safari™ and the like, a user at any one of the client devices 120 can interface with the animation tool that resides centrally at the server 110. This interface is typically via a web page that will effect generation of a graphical user interface to the server 110 on the client devices 120.

The server includes a plurality of datastores 111, each of which may be configured to store specific data elements that may be usefully employed by the user as part of the usage of the animation tool. A processor 112 provides the necessary processing requirements for the animation tool to process the user commands which are receivable through the graphical user interface, typically by mouse action by the user at the client device.

The animation tool includes a graphical user interface to a datastore providing a plurality of graphical elements which can be individually selected by the user and placed onto a worksheet. The graphical user interface is provided on a browser window 200 such as may be provided by MOZILLA™ Internet Explorer™, Safari™ and the like and is configured to portion the available client screen into distinct regions; a first region 210 being provided as the worksheet area where a user can pick and place graphical elements for subsequent generation of an animation. A second region 215 which is desirably dimensioned smaller than the first region provides graphical representations of each of the available graphical elements that are available. A third region 220 which is also desirably dimensioned smaller than the first region provides graphical representations of each of graphical element effects that may be applied onto each of the graphical elements. The second and third regions desirably occupy the same location on the user interface but are not viewable at the same time. By using a tab menu, it is possible to interchange between the elements that are provided as graphical elements, i.e. the population of the second region, and those that are graphical element effect, i.e. the population of the third region.

A management region 230 is provided as part of the graphical user interface and by manipulation of items within this region the user may effect changes in the number of frames 235 or length of individual frames for the animation being created. Using the mouse as a interface tool the user can simply stretch or shrink individual frames so as to enable the time of that frame to be modified.

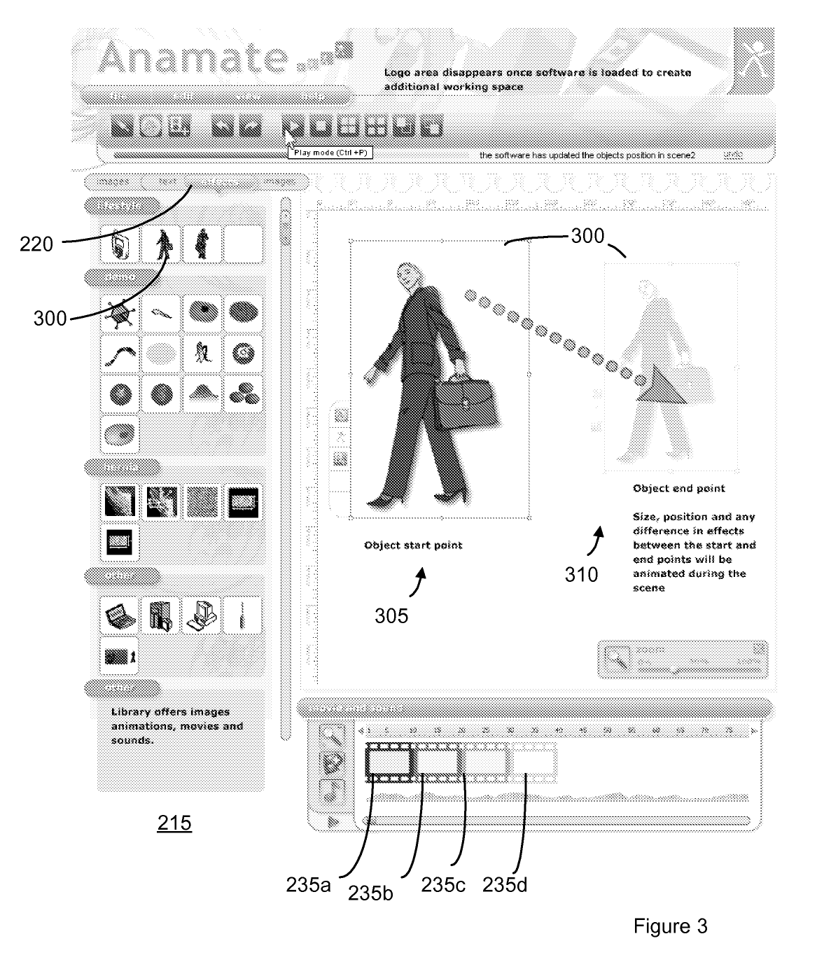

As shown in FIG. 3, using the animation tool of the present specification a user when generating a frame 235a of a specific animation simply selects a graphical element 300 from the first region and drags that element to a specific start location 305 within the first region. This start location will have specific grid coordinates which the animation tool records based on where the user has located that graphical element. As part of the desired frame the user will then wish that same graphical element to move to another location. This may be simply achieved by locating the same graphical element at a second different location 310. The animation tool will record that second location on a placing of the graphical element at that location by the user. By this simple action of positioning the same graphical element at two separate locations within the first region, the processor of the animation tool is configured to program an animation effect causing the element to operably move from the first location to the second location. The actual dimensions of the graphical element at any one location can also be modified by the user stretching or shrinking that graphical element at its location within the first region using the mouse as the interface tool.

The time duration from which the graphical element 300 takes to complete the movement from the first location 305 to the second location 310 will be determined by the user shrinking or stretching the frame 235a provided as part of the management region. In this exemplary arrangement the complete animation includes 4 frames, 235a, 235b, 235c & 235d—each of which can be populated as just described. The duration of any one of the frames can be independently determined relative to the others.

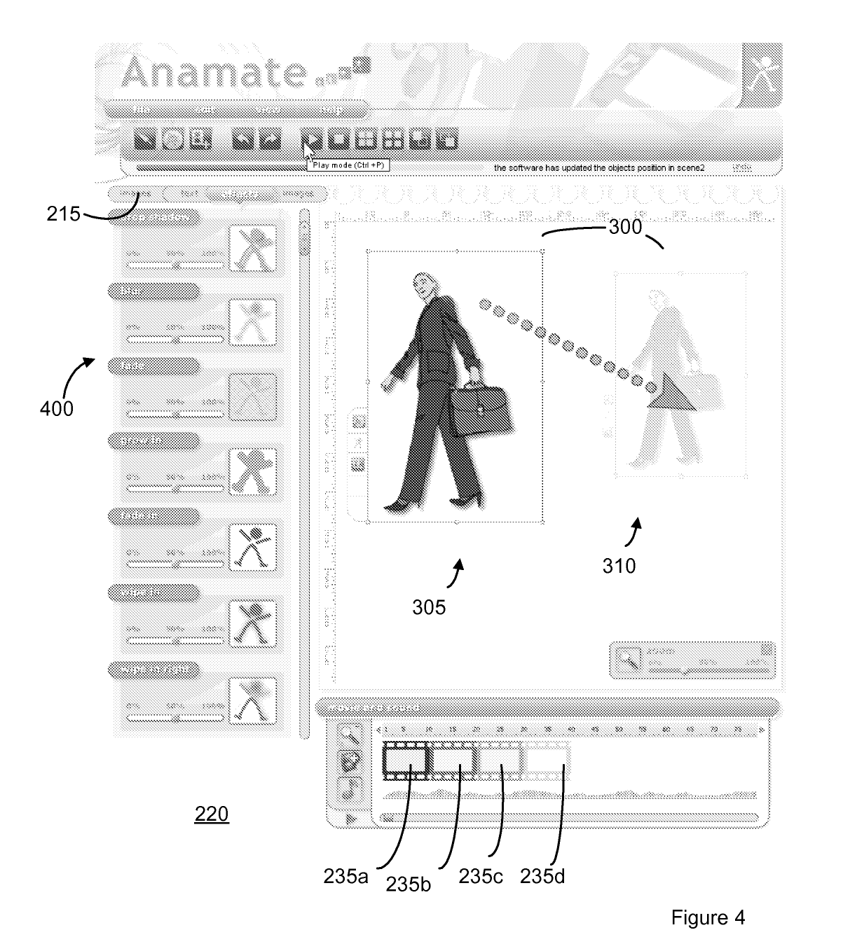

As part of any frame, movement of a graphical element from one location to another may be required. The frame may also require a graphical effect to be applied to that element. Examples of graphical effects include the application of shadows, blur effects, wipeouts etc. In accordance with the teaching of the present invention such effects are independently applied to graphical elements—i.e. pre-stored graphical elements with these effects hard coded into them are not required. In contrast to such arrangements the animation tool provides a datastore or library of desired effects and these are accessible to the user through the second region. Once a desired graphical element has been located on the first region, the effects that may be applied to that graphical element are available to the user by the user tabbing across to replace the second region with the third region. In FIG. 3, the first region 215 is visible but by the user clicking on the tab 220 he is then able to replace the visible elements of the first region 215 with graphical image effects 400 from the second region 220—as shown in FIG. 4.

The user may then select using their mouse a particular graphical effect 400 and by dragging that onto the desired graphical element 300 that is already present within the first region can apply that effect to that graphical element. On identification by the processor of the animation tool that a graphical element effect has been associated with a graphical element, the processor is configured to read the underlying code that is associated with that effect and apply it onto the features of the graphical element. All of this is transparent to the user in that the user needs no knowledge of software code or the like to provide a desired effect—all they need to do is drag a graphical element into a frame and associate that element with an effect by dragging the effect subsequently onto the element.

As was mentioned above, it will be appreciated from a comparison of FIGS. 3 and 4 that each of the second and third regions are desirably provided on the same area of the screen but are sequentially viewable by the user through a tab menu whereby the first and second region will interchange.

The tool enables a user to select individual graphical elements from the second region and place them using a mouse onto the first region. The desired graphical element effect for that graphical element may then be associated with that graphical element by dragging that effect from the third region onto the appropriate graphical element that is provided on the first region. It will be appreciated that the effects and the elements are orthogonal to one another in that the attributes of the graphical element are independent of the properties resultant from association of the graphical element effect with that graphical element.

By separating the nature of effects that may be applied to graphical elements and the graphical elements themselves the animation tool requires much less hard coding into the datastore of ultimate images. Each of the effects are applied separately and dynamically to user selected images. In this way more effort can be made on generating individual graphical elements as opposed to having to provide the same graphical element with a plurality of different effects applied thereto a priori for subsequent selection by the user.

Such an animation tool may be provided as a server executable application which is accessible through conventional browser technology. The animations may be generated in any one of a number of different file formats with the standard Flash™ file format for use in presentations or for website Flash™ animations being particularly well suited to the simplicity of the animations that may be conveniently generated using such a tool. In this way the user may access the animation tool provided by the teaching of the present invention, generate an animation and then store that animation for use in one or more other applications subsequently. The essence of the user simplicity of the tool derives from the fact that it is web based and the way in which animation is handled. Each of the graphical elements and graphical element effects have an XML description a FLASH based processor provided as part of the server architecture interprets the XML and renders the intended animation on the screen. Users do not have to learn XML in order to describe the desired animation but can do so by manipulating the objects on screen. Animations described in this way can then be read by the animation tool and displayed in a web browser as they are rendered in standard file formats.

The tool is particularly suited for construction of animations using a scene-based metaphor. In each scene the user can place a number of objects and can animate objects by applying effects and also be creating a copy of the object that serves as an animation target. To create animations the user simply moves, resizes or edits the animation target. The scenes in the animation are represented in a timeline enabling global manipulation. Rather than being frame based, requiring detailed control of image movement, the animation tool only requires the user to indicate scenes each with their own the start and end points of a sequence. The software handles the intervening movement and it does so for multiple images at the same time. The interface uses the timeline concept found in movie making.

The graphical elements and the graphical effects are provided as part of a library which is stored on the server and accessible through each of the second and third regions. Desirably the elements in image form are provided are high resolution vector drawings based on the flash vector file format, swf. Images in the swf format take up less internet resources than other images and also scale to larger sizes without losing image quality, making them ideally suited to our project. There is also support for animation within the swf format which sets it apart from other vector file formats, such as, SVG software and image manipulation is facilitated using familiar concepts from standard desktop applications. However, user input formats such as jpeg etc are also supported by the tool.

It will be appreciated that what has been described herein is an exemplary arrangement of an animation tool which is configured to enable a user to generate one or more animations for subsequent execution on a computer platform is described. These generated animations are provided as an output from the animation tool in a format that enables them to be executed on any one of a number of standard computing platforms or embedded into one or more presentation tools such as for example Microsoft™ Powerpoint™. The output animations are provided in any one of a number of user selectable file formats. The animation tool provides a plurality of graphical integers which a user can use to generate an animation. The graphical integers are divisible into graphical elements and graphical element effects, the effects being applied by a user onto an element and defining the viewing properties of that element. Modifications can be made to what has been described herein without departing from the spirit and or scope of the claimed invention.

The words comprises/comprising when used in this specification are to specify the presence of stated features, integers, steps or components but does not preclude the presence or addition of one or more other features, integers, steps, components or groups thereof.

1. A computer implemented animation tool provided in a client server architecture, the tool providing a graphical user interface via a browser window to a datastore on a server having a plurality of graphical elements which can be individually selected by the user stored thereon, and wherein the server configures the graphical user interface to define on a user client window a plurality of distinct regions, the regions including:
a first region providing a worksheet area where a user can pick and place graphical elements for subsequent generation of an animation,
a second region which is desirably dimensioned smaller than the first region providing graphical representations of each of a plurality of available graphical elements that are available for selection from the datastore,
a third region also desirably dimensioned smaller than the first region and providing graphical representations of each of a plurality of graphical element effects that may be applied onto each of the graphical elements, and
wherein the server is configured to be responsive to mouse action by a user at a client machine to enable the user to interface with each of the first, second and third regions to generate an animation for subsequent display.

2. The tool of claim 1 wherein each of the second and third regions are defined so as to be provided on a same area of the client screen but are sequentially viewable by a user through a tab menu whereby the first and second regions will interchange.

3. The tool of claim 1 wherein the server is configured to be responsive to mouse action by a user at a client machine to enable the user to select and place individual graphical elements from the second region onto the first region.

4. The tool of claim 3 wherein the server is configured to be responsive to mouse action by a user at a client machine to enable the user to associate graphical element effects for a previously selected graphical element by dragging a graphical representation of that effect from the third region onto the appropriate graphical element that is provided within the first region.

5. The tool of claim 1 wherein each of the graphical elements and graphical element effects are independent to one another in that the attributes of the graphical element are independent of the properties resultant from association of the graphical element effect with that graphical element.

6. The tool of claim 1 wherein each of the graphical elements and graphical element effect have computer code associated therewith, the computer code defining the functionality of the graphical element and graphical element effects.

7. The tool of claim 6 including a compiler configured to generate from the graphical elements provided on the first region an executable animation which may be stored and played subsequently.

8. The tool of claim 3 wherein the server is responsive to mouse action by a user at a client machine to enable the user to move a previously placed individual graphical element from a first location on the first region to a second location on the first region, the server being configured to associate the movement with a movement of the graphical element in an animation sequence.

9. The tool of claim 8 wherein the server is responsive to mouse action by a user at a client machine to define the time period for the movement of the graphical element from the first location to the second location.

10. The tool of claim 9 wherein the server configures the graphical user interface to define on a user client window a fourth region, the fourth region including graphical representations of an animation frame, a stretching or shrinking of that graphical representation of the animation frame by user mouse action effecting a lengthening or shorting of the time of that frame in a generated animation.

11. The tool of claim 10 wherein the fourth region defines the number of frames in a generated animation and the length of any one of those frames.

12. The tool of claim 3 wherein the server is configured to be response to mouse action by a user at a user client window to associate two or more graphical elements with one another such that movement of a first graphical element effects corresponding movement of a second graphical element.

13. The tool of claim 1 wherein the server is configured to generate the animation in a platform agnostic file format such that a generated animation may be used in a plurality of software applications or environments.

14. The tool of claim 1 comprising a third party interface whereby a third party upload previously created graphical elements or graphical element effects for use by other users of the animation tool, the uploaded graphical elements or graphical element effects being provided to the other users through the second and third regions.

15. A computer implemented animation methodology comprising:
providing on a server a datastore having a plurality of graphical elements and graphical element effects stored thereon;
providing a client web interface to the server, the client interface including a graphical user interface generated on a client machine and being responsive to mouse actions by a user at their client interface to allow the user to select one or more graphical elements and/or graphical element effects, the client interface generating a user specific session on the server for processing of the selected graphical elements and/or graphical element effects;
enabling the user through action at the client machine to combine and manipulate selected graphical elements within the user specific session to generate an executable animation for subsequent storage and display.
